(19) United States
(12) Patent Application Publication
(10) Pub. No.: US 2026/0188704 A1
(43) Pub. Date: Jul. 2, 2026

(54) GAS DIFFUSION LAYER AND METHOD FOR MANUFACTURING SAME, MEMBRANE ELECTRODE ASSEMBLY, AND FUEL CELL

(71) Applicant: Panasonic Intellectual Property Management Co., Ltd., Osaka (JP)

(72) Inventors: Hiro NODAKA, Osaka (JP); Tsutomu KAWASHIMA, Nara (JP)

(21) Appl. No.: 19/544,250

(22) Filed: Feb. 19, 2026

Related U.S. Application Data
(63) Continuation of application No. PCT/JP2024/036483, filed on Oct. 11, 2024.

(30) Foreign Application Priority Data
Oct. 13, 2023 (JP) 2023-177729

(51) Int. Cl. H01M 4/86; H01M 8/1004

(52) U.S. Cl. CPC H01M 4/8652; H01M 4/8605; H01M 8/1004

(57) ABSTRACT

A gas diffusion layer includes: a porous member containing conductive particles, conductive fibers, and a polymer resin, wherein the polymer resin has polymer resin particles presenting in particulate form, and the polymer resin includes two or more polymer resin particles fused together in part.

### CROSS REFERENCE TO RELATED APPLICATION

This application claims priorities of Japanese Patent Application No. 2023-177729 filed on Oct. 13, 2023 and PCT Application No. PCT/JP2024/036483 filed on Oct. 11, 2024, the contents of which are incorporated herein by reference.

### BACKGROUND OF THE INVENTION

### 1. Field of the Invention

The present disclosure relates to a gas diffusion layer, a method for manufacturing the gas diffusion layer, a membrane electrode assembly, and a fuel cell.

### 2. Description of the Related Art

A single cell of a polymer electrolyte fuel cell includes a membrane electrode assembly (hereinafter, it is abbreviated as “MEA”) and a separator. The MEA includes an electrolyte membrane and an electrode layer. The electrode layer includes a catalyst layer and a gas diffusion layer. The gas diffusion layer is required to have gas permeability, gas diffusibility, and conductivity, and a conductive porous member is used. The gas diffusion layer is required to have water repellency, and a gas diffusion layer provided with a water repellent layer is generally used.

Japanese Patent No. 4938133 B as Patent Document 1 discloses a gas diffusion layer composed of a porous member containing conductive particles and a polymer resin as main components. Japanese Patent Application Laid-open No. 2021-197245 A as Patent Document 2 discloses a gas diffusion layer containing conductive particles and a fluororesin, in which the fluororesin contains a first fiber having a first average fiber diameter and a second fiber having a second average fiber diameter different from the first average fiber diameter.

However, there is a demand for a gas diffusion layer in which the degree of fiberization of a polymer resin is further increased and the mechanical strength is increased.

### SUMMARY

The present disclosure is intended to solve the above-mentioned problems, and one non-limiting and exemplary embodiments provides a gas diffusion layer containing conductive fibers, conductive particles, and a polymer resin as main components and having excellent mechanical strength.

In one general aspect, the techniques disclosed here feature: a gas diffusion layer includes a porous member, the porous member containing conductive particles, conductive fibers, and a polymer resin,
wherein the polymer resin has polymer resin particles presenting in particulate form, and
the polymer resin includes two or more polymer resin particles fused together in part.

In another general aspect, the techniques disclosed here feature: a membrane electrode assembly includes:
the gas diffusion layer;
a pair of electrodes; and
an electrolyte membrane.

In another general aspect, the techniques disclosed here feature: a fuel cell comprising:
the membrane electrode assembly; and
a current collecting plate.

In another general aspect, the techniques disclosed here feature: a method for manufacturing a gas diffusion layer, the method comprising:
kneading conductive particles, conductive fibers, and a polymer resin in a dispersion solvent to obtain a kneaded product in which a degree of fiberization of the polymer resin is 50% or less; and
rolling the kneaded product to obtain a sheet in which the degree of fiberization of the polymer resin is less than 50%.

In another general aspect, the techniques disclosed here feature: a method for manufacturing a gas diffusion layer, the method comprising:
kneading conductive particles, conductive fibers, a polymer resin, and crushing auxiliary particles having a specific gravity of twice or more a specific gravity of the conductive particles, and crushing and dispersing the conductive particles, the conductive fibers, and the polymer resin with the crushing auxiliary particles to obtain a kneaded product; and
rolling the kneaded product obtained by the kneading, and forming a sheet to obtain a gas diffusion layer composed of the sheet.

In another general aspect, the techniques disclosed here feature: a method for manufacturing a gas diffusion layer, the method comprising:
kneading conductive particles, conductive fibers, and a polymer resin in a dispersion solution having an added amount of a dispersant of 1 wt % or more and 5 wt % or less to obtain a kneaded product;
adding second conductive particles having a specific surface area of 2 times or more and 20 times or less the conductive particles to the kneaded product obtained by the kneading and kneading the second conductive particles; and
rolling the kneaded product to form a sheet to obtain a gas diffusion layer composed of the sheet.

According to the gas diffusion layer of the present disclosure, since the mechanical strength of the gas diffusion layer is improved, it is possible to suppress deformation due to an external force such as vibration or impact and deformation during long-time operation of the fuel cell, and to prolong the life of the fuel cell.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 is a schematic perspective view showing a configuration of a polymer electrolyte fuel cell stack according to a first embodiment of the present disclosure;

FIG. 2 is a schematic cross-sectional view showing a cross-sectional structure of the polymer electrolyte fuel cell according to the first embodiment of the present disclosure;

FIG. 3A is an enlarged schematic view of a gas diffusion layer according to the first embodiment of the present disclosure;

FIG. 3B is an SEM photograph of the gas diffusion layer according to the first embodiment of the present disclosure;

FIG. 4A is an enlarged schematic view of a gas diffusion layer according to a second embodiment of the present disclosure;

FIG. 4B is an SEM photograph of the gas diffusion layer according to the second embodiment of the present disclosure;

FIG. 5A is an enlarged schematic view of a gas diffusion layer according to a third embodiment of the present disclosure;

FIG. 5B is an SEM photograph of the gas diffusion layer according to the third embodiment of the present disclosure;

FIG. 6A is an SEM photograph of a gas diffusion layer according to calculation of a degree of PTFE fiberization and a PTFE fiber amount of the present disclosure;

FIG. 6B is phase separation images of a C phase and a CF phase by EDX relating to calculation of a degree of PTFE fiberization and a PTFE fiber amount of the present disclosure;

FIG. 7 is a flowchart showing a method for manufacturing the gas diffusion layer according to the first and second embodiments of the present disclosure; and

FIG. 8 is a flowchart showing a method for manufacturing a gas diffusion layer according to a third embodiment of the present disclosure.

### DETAILED DESCRIPTION

A gas diffusion layer according to a first aspect, includes a porous member, the porous member containing conductive particles, conductive fibers, and a polymer resin,
wherein the polymer resin has polymer resin particles presenting in a particulate form, and
the polymer resin includes two or more polymer resin particles fused together.

The gas diffusion layer according to a second aspect in addition to the first aspect, the polymer resin may have polymer resin fibers presenting in fibrous form, and
when a degree of fiberization of the polymer resin is defined as a ratio of the polymer resin fibers to the polymer resin, a degree of fiberization of the polymer resin may be 50% or more.

The gas diffusion layer according to a third aspect in addition to the first or second aspect, the polymer resin may have polymer resin fibers presenting in fibrous form, and
a fiber amount as a ratio of the polymer resin fibers to the entire porous member may be 3 wt % or more.

The gas diffusion layer according to a fourth aspect in addition to any one of first to third aspects, the polymer resin may include films formed by melting of two or more polymer resin particles.

The gas diffusion layer according to a fifth aspect in addition to any one of first to fourth aspect, further may include crushing auxiliary particles having a specific gravity of 2 times or more and 20 times or less than the specific gravity of the conductive particles.

The gas diffusion layer according to a sixth aspect in addition to the fifth aspect, the crushing auxiliary particles may be cerium-containing oxide.

The gas diffusion layer according to a seventh aspect in addition to any one of first to sixth aspects, the porous member may contain:
5 wt % or more and less than 35 wt % of the conductive particles;
35 wt % or more and 80 wt % or less of the conductive fibers;
0 wt % or more and 40 wt % or less of the polymer resin; and
0 wt % or more and 30 wt % or less of the crushing auxiliary particles.

The gas diffusion layer according to an eighth aspect in addition to any one of first to seventh aspects, the polymer resin may contain polytetrafluoroethylene.

A membrane electrode assembly according to a ninth aspect includes:
the gas diffusion layer according to any one of first to eighth aspects;
a pair of electrodes; and
an electrolyte membrane.

A fuel cell according to a tenth aspect includes:
the membrane electrode assembly according to the ninth aspect; and
a current collecting plate.

A method for manufacturing a gas diffusion layer according to an eleventh aspect, the method includes:
kneading conductive particles, conductive fibers, and a polymer resin in a dispersion solvent to obtain a kneaded product in which a degree of fiberization of the polymer resin is less than 50%; and
rolling the kneaded product to obtain a sheet in which the degree of fiberization of the polymer resin is less than 50%.

The method for manufacturing a gas diffusion layer according to a twelfth aspect in addition to the eleventh aspect, the kneading may be carried out in dispersion solution in which an added amount of a dispersant may be 1 wt % or more and 5 wt % or less.

The method for manufacturing a gas diffusion layer according to a thirteenth aspect in addition to the eleventh or twelfth aspect, further may include firing a sheet in which the polymer resin has a degree of fiberization of less than 50% to obtain a gas diffusion layer in which the polymer resin has a degree of fiberization of 50% or more.

A method for manufacturing a gas diffusion layer according to a fourteenth aspect, the method includes:
kneading conductive particles, conductive fibers, a polymer resin, and crushing auxiliary particles having a specific gravity of twice or more a specific gravity of the conductive particles, and crushing and dispersing the conductive particles, the conductive fibers, and the polymer resin with the crushing auxiliary particles to obtain a kneaded product; and
rolling the kneaded product obtained by the kneading, and forming a sheet to obtain a gas diffusion layer composed of the sheet.

The method for manufacturing a gas diffusion layer according to a fifteenth aspect in addition to the twelfth aspect, further may include:
adding second conductive particles having a specific surface area of 2 times or more and 20 times or less the conductive particles to the kneaded product obtained by the kneading and kneading the second conductive particles.

Hereinafter, a gas diffusion layer, a method for manufacturing the gas diffusion layer, a membrane electrode assembly, and a fuel cell according to an embodiment of the present disclosure will be described with reference to the accompanying drawings.

### First Embodiment

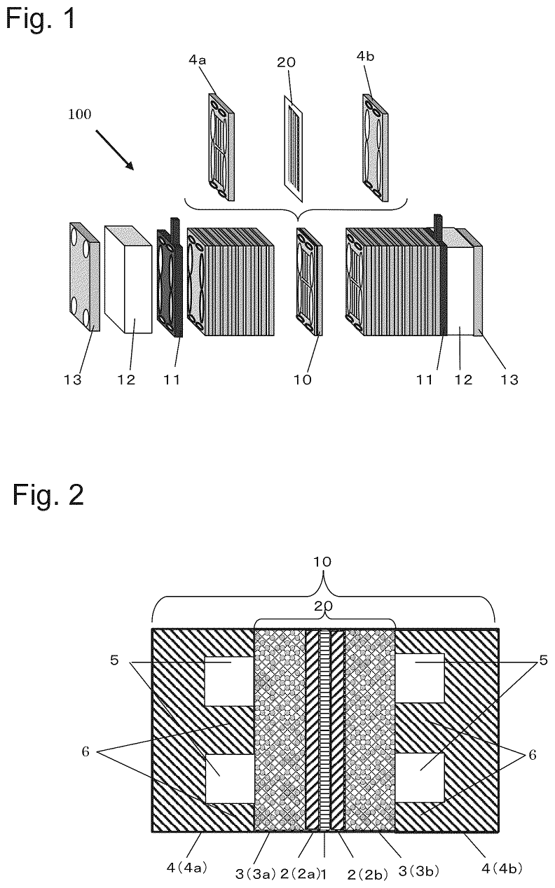

A basic configuration of a fuel cell 100 according to a first embodiment of the present disclosure will be described with reference to FIG. 1. FIG. 1 is a schematic perspective view illustrating a configuration of the fuel cell (hereinafter, also referred to as a “polymer electrolyte fuel cell stack”) 100 according to the first embodiment. The present embodiment is not limited to the polymer electrolyte fuel cell, and can be applied to various fuel cells.

### <Fuel Cell>

As shown in FIG. 1, in the fuel cell 100, one or more battery cells 10 as a basic unit are stacked, and compressed and fastened with a predetermined load using current collecting plates 11, insulating plates 12, and end plates 13 disposed on both sides of the stacked battery cells 10.

The current collecting plate 11 is formed of a gas-impermeable conductive material. For example, copper, brass, or the like is used for the current collecting plate 11. The current collecting plate 11 is provided with a current extraction terminal portion (not shown), and a current is extracted from the current extraction terminal portion during power generation.

The insulating plate 12 is formed of an insulating material such as resin. For example, a fluorine-based resin, a PPS resin, or the like is used for the insulating plate 12.

The end plates 13 fasten and hold one or more stacked battery cells 10, the current collecting plates 11, and the insulating plates 12 with a predetermined load by a pressurizing means (not shown). A highly rigid metal material such as steel is used for the end plate 13.

FIG. 2 is a schematic cross-sectional view showing a cross-sectional structure of the battery cell 10. In the battery cell 10, the membrane electrode assembly (hereinafter, also referred to as MEA) 20 is sandwiched between an anode side separator 4a and a cathode side separator 4b. Hereinafter, the anode side separator 4a and the cathode side separator 4b are collectively referred to as a separator 4. In a case where a plurality of other components are described together, the same description will be made.

A fluid flow path 5 is formed in the separator 4. A fluid flow path 5 for fuel gas is formed in the anode side separator 4a. A fluid flow path 5 for oxidant gas is formed in the cathode side separator 4b. A carbon-based material and a metal-based material can be used for the separator 4.

The fluid flow path 5 is a groove formed in separator 4. A rib portion 6 is provided around the fluid flow path 5.

### <Membrane Electrode Assembly: MEA>

A membrane electrode assembly (MEA) 20 includes a polymer electrolyte membrane 1, a catalyst layer 2, and a gas diffusion layer 3. An anode catalyst layer 2a and a cathode catalyst layer 2b (combined catalyst layer 2) are formed on both surfaces of the polymer electrolyte membrane 1 that selectively transports hydrogen ions, and an anode-side gas diffusion layer 3a and a cathode gas diffusion layer 3b (combined gas diffusion layer 3) are disposed outside the anode catalyst layer 2a and the cathode catalyst layer 2b, respectively.

For the polymer electrolyte membrane 1, for example, a perfluorocarbon sulfonic acid polymer is used, but it is not particularly limited as long as it has proton conductivity.

As the catalyst layer 2, a layer containing a carbon material carrying catalyst particles such as platinum and a polymer electrolyte can be used.

### <Gas Diffusion Layer 3>

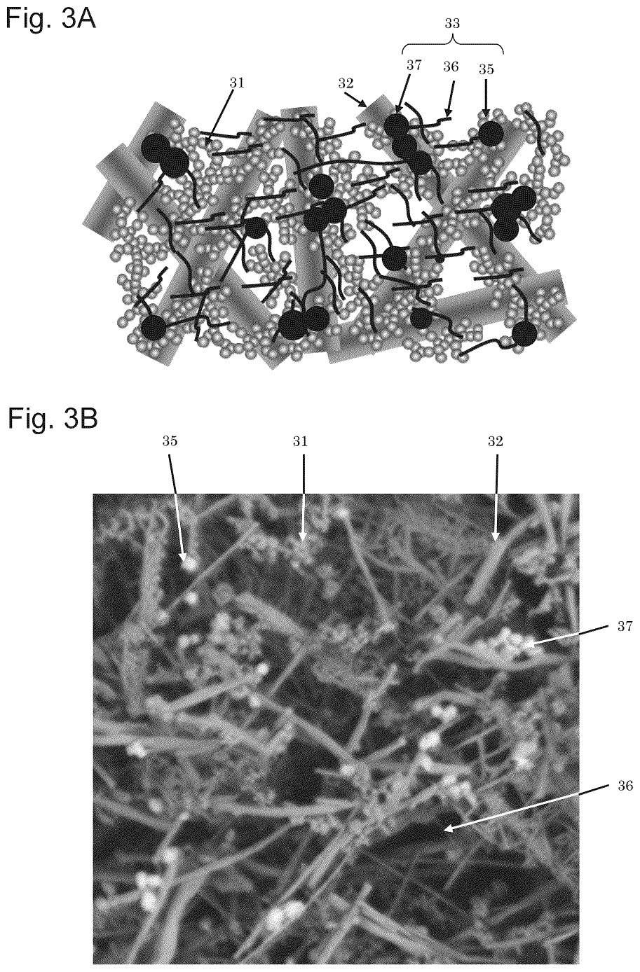

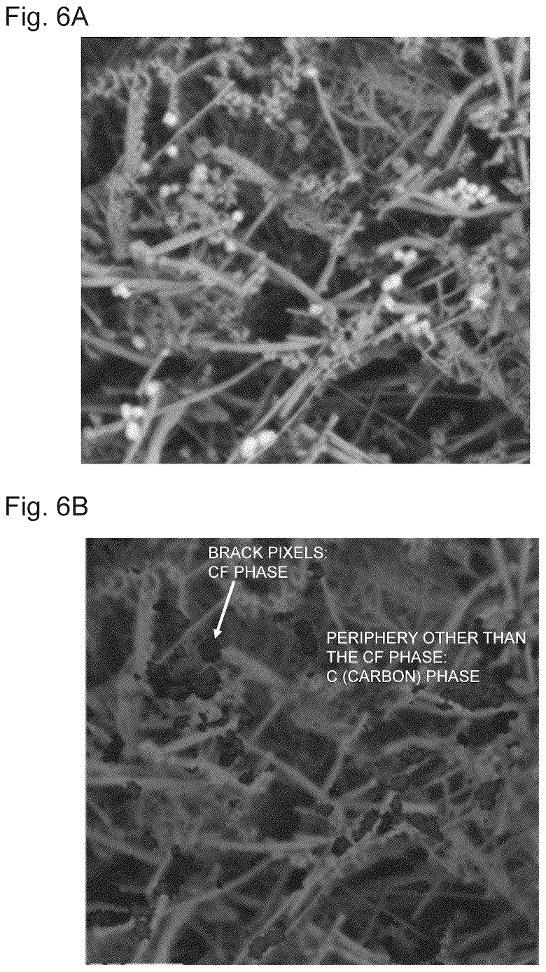

Next, a configuration of the gas diffusion layer 3 according to the first embodiment of the present disclosure will be described in detail with reference to FIGS. 3A, 3B, 6A, and 6B.

FIG. 3A is an enlarged schematic view in which a part of the gas diffusion layer 3 is enlarged, and FIG. 3B is an SEM photograph. The gas diffusion layer 3 is composed of conductive particles 31, conductive fibers 32, and a polymer resin 33, and the polymer resin 33 is present in various forms such as a single particle (polymer resin particle) 35, a fibrous (polymer resin fiber) 36, and an aggregate 37 in which two or more single particles are aggregated and the particles are fused to each other.

When the degree of fiberization of the polymer resin is defined as the ratio of the polymer resin 33 presenting in a fibrous form (polymer resin fiber), the degree of fiberization of the polymer resin is 50% or more. The degree of fiberization is more preferably 60% or more.

PTFE, which is the polymer resin 33, is particulate at the raw material stage, but is turned into a fiber by a shear force, and the PTFE fibers 36 are entangled with the conductive particles 31 and the conductive fibers 32, thereby securing mechanical strength. Therefore, when the degree of fiberization of PTFE is 50% or more, the mechanical strength of the gas diffusion layer 3 can be improved, and strength that can withstand the pressure of gas and generated water during power generation can be obtained. When the degree of fiberization of PTFE is less than 50%, it is established as a free-standing film, but it is damaged by the pressure of gas or generated water during power generation.

Among the polymer resins, the polymer resin present in a fibrous form has a fiber amount of 3 wt % or more. The fiber amount is more preferably 4 wt % or more.

As described above, since the PTFE fiber 36, which is a polymer resin, ensures the mechanical strength of the gas diffusion layer 3, the mechanical strength of the gas diffusion layer 3 decreases when the PTFE fiber amount is small.

The fiber amount of PTFE which is a polymer resin can be increased by increasing the degree of fiberization of PTFE or increasing the added amount of PTFE.

When the fiber amount of PTFE, which is a polymer resin, is less than 3 wt %, the mechanical strength is reduced, and the PTFE is damaged by the pressure of gas or generated water during power generation.

### <Method for Calculating Degree of Fiberization and Fiber Amount of Polymer Resin in Gas Diffusion Layer 3>

A method for calculating the degree of fiberization and the fiber amount of the polymer resin in the gas diffusion layer 3 will now be described with reference to FIGS. 6A and 6B. As shown in FIGS. 6A and 6B, the degree of fiberization of the polymer resin in the gas diffusion layer 3 is calculated by phase separation of EDX image measurement results using SEM of the surface or cross section of the gas diffusion layer 3. For example, phase separation can be performed using the software AZtec4.3 from Oxford Instrument.

The phase analysis will now be described. The EDX image measurement result has a spectrum for each pixel. By performing calculation processing on the spectrum of each pixel obtained by the EDX image measurement, it is possible to obtain a phase analysis image (FIG. 6B) in which pixels having similar spectra are grouped. From this phase analysis image, the area ratio of each phase in the image visual field and the composition ratio by quantitative analysis of the spectrum can be calculated. In the first embodiment focusing on fluorine (F) contained in polymer resin PTFE and carbon (C) contained in conductive particles and conductive fibers, which are carbon materials, grouping was performed into two phases of a CF phase based on fluorine (F) and a C phase based on carbon (C). In FIG. 6B, the CF phase is indicated by black pixels, while the periphery other than the CF phase is the C phase. Since the fibers of PTFE are so thin that it is difficult to observe them by SEM, and the amount of detection per area is small, the F concentration in the C-phase, which is mainly composed of C, correlates with the amount of PTFE fibers. Therefore, the fiber amount and the degree of fiberization are calculated as shown in the following equations.

(Fiber amount)=C-phase area ratio×C-phase F concentration

(Degree of fiberization)=C-phase area ratio×C-phase F concentration/phase analysis image F concentration

The gas diffusion layer 3 may be formed of a porous member containing the conductive particles 31, the conductive fibers 32, and the polymer resin 33, the porous member may contain the polymer resin particle 35 in a particulate form, and a part of the polymer resin particle 35 in a particulate form may be present as the aggregate 37 in which two or more polymer resin particles are fused (in part).

As described above, PTFE, which is a polymer resin, is particulate at the raw material stage. In the step of kneading the conductive particles, the conductive fibers, and particulate PTFE to disperse the PTFE particles, some of the PTFE particles are not dispersed to single particles, and two or more particles are present in an aggregated state. Thereafter, the gas diffusion layer 3 is manufactured through a sheet forming step and a firing step, and two or more aggregated PTFE particles are fused in the firing step and are brought into close contact with the conductive particles and the conductive fibers, whereby the strength of the gas diffusion layer 3 can be improved.

### <Types of Conductive Particles 31, Conductive Fibers 32, and Polymer Resin 33>

Examples of the conductive particles 31 include carbon materials such as carbon black, graphite, and activated carbon. Among them, it is preferable to use carbon black having high conductivity and a large pore volume. As the carbon black, acetylene black, Ketjen black, furnace black, and Vulcan can be used. Among them, acetylene black having a small impurity amount or ketjen black having a large specific surface area and high conductivity is preferably used. As the conductive particles, fullerenes such as C60 fullerene may be used.

In the size of the conductive particles, for example, D50 is 10 nm or more and 5 μm or less. Furthermore, for example, D50 may be 10 nm or more and 500 nm or less, and may be 10 nm or more and 100 nm or less. When the conductive particles are carbon black, for example, the primary particle diameter may be 10 nm or more and 500 nm or less and 10 nm or more and 100 nm or less, and the size of the aggregate (primary aggregate) may be, for example, 100 nm or more and 500 nm or less. When the conductive particles are graphite or activated carbon, for example, D50 is 1 μm or more and 5 μm or less.

The conductive fibers 32 contribute to improvement of conductivity and improvement of mechanical strength of the gas diffusion layer 3. The material of the conductive fibers 32 is not particularly limited, but for example, carbon fibers such as carbon nanotubes can be used.

The average fiber diameter of the conductive fibers 32 is preferably 50 nm or more and 300 nm or less. When the average fiber diameter of the conductive fibers 32 is 50 nm or more, it is possible to more effectively contribute to improvement of conductivity of the gas diffusion layer 3 and to further enhance mechanical strength of the gas diffusion layer 3. Thus, the gas diffusion layer 3 can have sufficient strength as a free-standing film. When the average fiber diameter of the conductive fibers 32 is 300 nm or less, the diameter does not become too large, so that the pore volume in the porous member 30 can be easily secured sufficiently. Accordingly, the gas diffusibility of the gas diffusion layer 3 can be further enhanced.

The average fiber length of the conductive fibers 32 is preferably 0.5 μm or more and 50 μm or less. When the average fiber length of the conductive fibers 32 is 0.5 μm or more, it is possible to more effectively contribute to improvement of conductivity of the gas diffusion layer 3 and to further enhance mechanical strength of the gas diffusion layer 3. When the average fiber length of the conductive fibers 32 is 50 μm or less, the fibers are not excessively long, so that the conductive fibers 32 are crushed without forming lumps during manufacturing, and the gas diffusibility of the gas diffusion layer 3 can be further enhanced.

Examples of the polymer resin 33 include PTFE (polytetrafluoroethylene), FEP (tetrafluoroethylene-hexafluoropropylene copolymer), PVDF (polyvinylidene fluoride), ETFE (tetrafluoroethylene-ethylene copolymer), PCTFE (polychlorotrifluoroethylene), and PFA (polyfluoroethylene-perfluoroalkyl vinyl ether copolymer). Among them, PTFE is preferably used as the polymer resin 33 from the viewpoint of heat resistance, water repellency, and chemical resistance. Examples of the raw material form of PTFE include dispersion, powder, and the like. Among them, dispersions are preferable because of excellent dispersibility. PTFE has a property of being fibrous when a shear force is applied. In a mixing/dispersion step or a step of forming a sheet during manufacturing the gas diffusion layer 3, a shear force is applied to PTFE as a material, so that PTFE becomes fibrous.

The polymer resin 33 has a function as a binder that binds the conductive particles 31 and the conductive fibers 32 to each other. The polymer resin 33 has water repellency, and therefore also has a role of preventing water from staying in pores inside the gas diffusion layer 3 and gas permeation from being inhibited.

Further, in the gas diffusion layer 3, the conductive particles 31 exist in gaps between the conductive fibers 32, and the conductive fibers 32 and the conductive particles 31 can be favorably bound by the polymer resin fibers (fibrous) of the polymer resin 33, so that the gas diffusion layer 3 can have sufficient strength.

### Second Embodiment

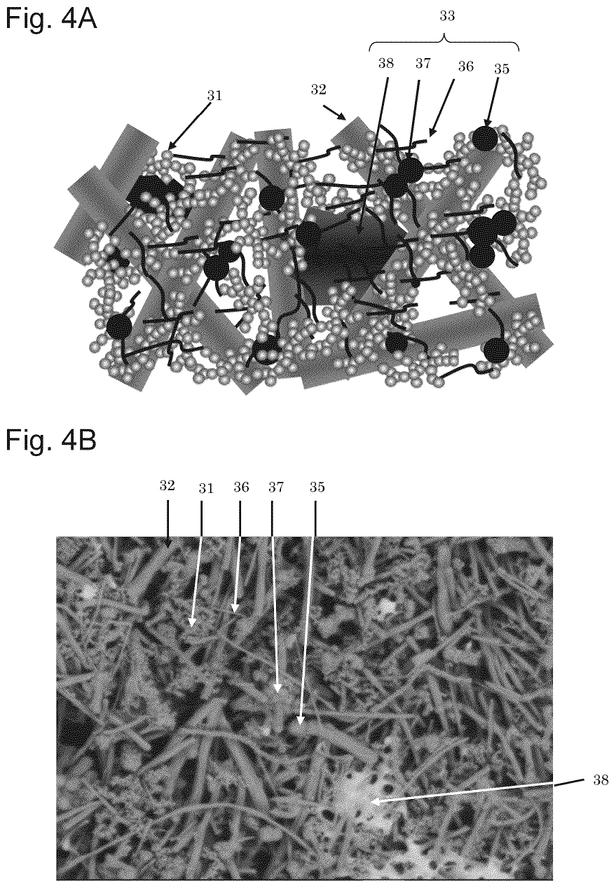

Next, a configuration of a gas diffusion layer 3 according to a second embodiment of the present disclosure will be described in detail with reference to FIGS. 4A and 4B.

FIG. 4A is an enlarged schematic view in which a part of the gas diffusion layer 3 is enlarged, and FIG. 4B is an SEM photograph. The gas diffusion layer 3 according to the second embodiment is composed of conductive particles 31, conductive fibers 32, and a polymer resin 33. The polymer resin 33 is present in the form of a single particle 35, a fibrous (polymer resin fiber) 36, an aggregate 37 in which two or more single particles (polymer resin particles) are aggregated and the particles are fused, and a film-like body 38 in which two or more polymer resin particles are melted.

As described above, in the firing step, two or more aggregated PTFE particles are fused, and a part thereof is further softened to be changed from a particulate form to a film form, and a gap with the conductive particles and the conductive fibers is filled, whereby the strength of the gas diffusion layer 3 can be further improved.

### Third Embodiment

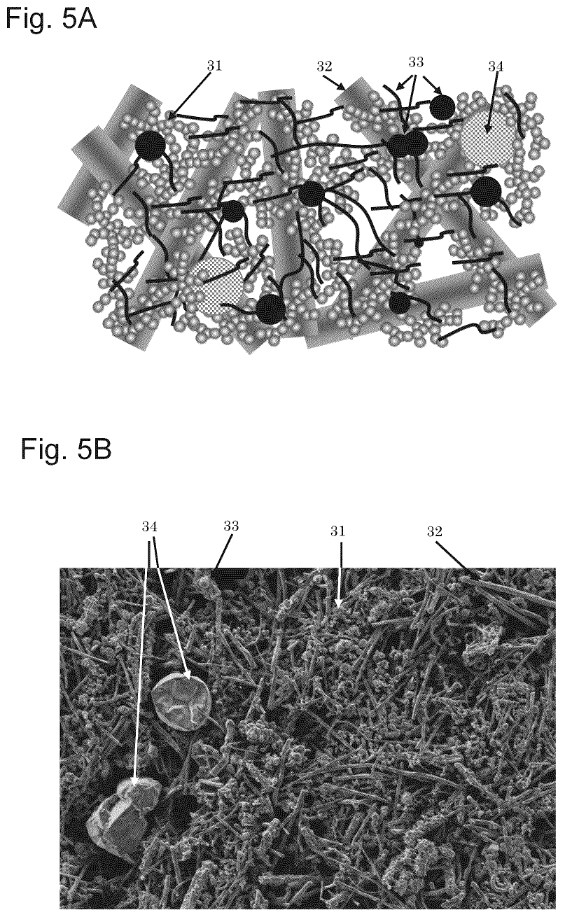

Next, a configuration of a gas diffusion layer 3 according to a third embodiment of the present disclosure will be described in detail with reference to FIGS. 5A and 5B.

FIG. 5A is an enlarged schematic view in which a part of the gas diffusion layer 3 according to the third embodiment is enlarged, and FIG. 5B is an SEM photograph. The gas diffusion layer 3 according to the third embodiment is composed of conductive particles 31, conductive fibers 32, a polymer resin 33 containing an aggregate of two or more polymer resin particles in particulate form and polymer resin fibers in fibrous form, and a crushing auxiliary particle 34.

The crushing auxiliary particles 34 have a role of rubbing against the conductive particles 31 and the conductive fibers 32 in a material kneading step during manufacturing to resolve and uniformly disperse the aggregates, and also imparting a shearing force to the particulate polymer resin 33 at the raw material stage to increase the degree of fiberization of the polymer resin.

### <Kinds of Crushing Auxiliary Particles 34>

The gas diffusion layer 3 may further contain crushing auxiliary particles 34 having a specific gravity of 2 times or more the specific gravity of the conductive particles 31. When the specific gravity of the crushing auxiliary particles 34 is 2 times or more the specific gravity of the conductive particles 31, the conductive particles 31 are further crushed in a mixing/dispersion step during manufacturing the gas diffusion layer 3, the surface area is increased, and the shearing force applied to the polymer resin particles is increased, so that the mechanical strength of the gas diffusion layer 3 can be increased.

The crushing auxiliary particles 34 may be water-insoluble particles, and for example, rare earth oxides, alkaline earth metal oxides, and ceramics are used, and more specifically, for example, cerium-containing oxides, manganese-containing oxides, zirconia, steatite, and the like are exemplified. Among them, as the crushing auxiliary particles 34, it is preferable to use cerium-containing oxides from the viewpoint of being able to expect the effect of radical quenching.

### <Method 1 for Manufacturing Gas Diffusion Layer 3>

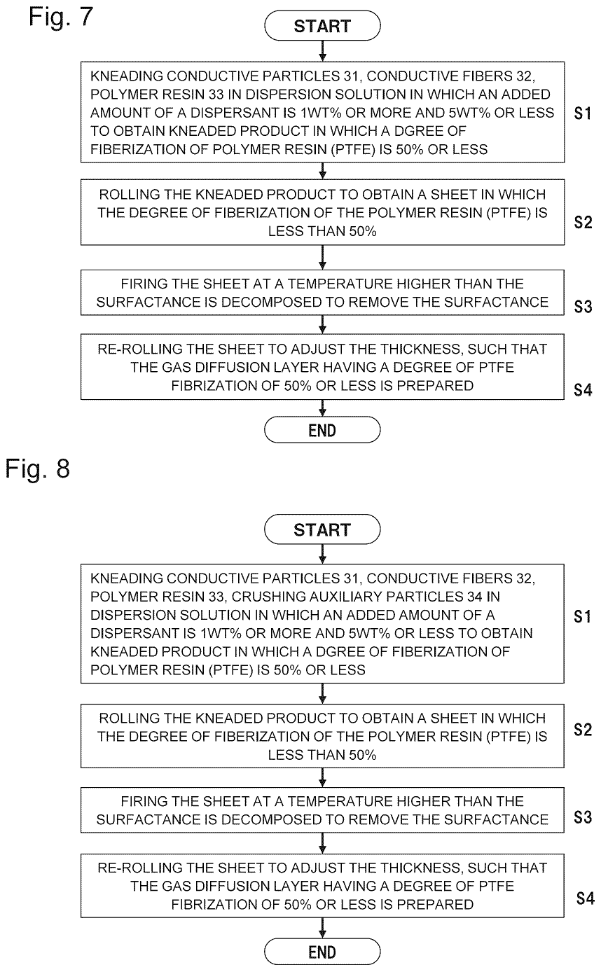

Next, a method for manufacturing the gas diffusion layer 3 according to the first and second embodiments will be described with reference to FIG. 7.

In step S1 of FIG. 7, conductive particles 31, conductive fibers 32, a polymer resin 33, a surfactant, and a dispersion solvent are kneaded. For the kneading of the material in step S1, for example, a planetary mixer, a rotation-revolution mixer, a kneader, a roll mill, or the like can be used. In step S1, which is a kneading step, the conductive particles 31, the conductive fibers 33, the surfactant, and the dispersion solvent are first kneaded and dispersed, and then the polymer resin 33 is charged and stirred, whereby the polymer resin 33 can be uniformly dispersed in the kneaded product.

In addition, by kneading the conductive particles 31, the conductive fibers 32, and the polymer resin 33 in a dispersion solution in which the added amount of the dispersant is 1 wt % or more and 5 wt % or less, kneading is performed in a paste state, and dispersibility can be enhanced. In a case where the added amount of the dispersant is less than 1 wt %, the conductive particles 31, the conductive fibers 32, and the crushing auxiliary particles 34 are not uniformly dispersed in the dispersion solvent, so that the structure of the gas diffusion layer 3 may be biased and the strength may be reduced. On the other hand, when the added amount of the dispersant is more than 5 wt %, the dispersant is excessive with respect to the conductive particles 31, the conductive fibers 32, and the crushing auxiliary particles 34. Therefore, when the kneaded product is rolled into a sheet shape in step S2, the shear force is not sufficiently applied due to sliding of the materials, so that the fiberization of the polymer resin 33 may be reduced and the strength may be reduced.

The degree of fiberization of PTFE, which is a polymer resin of the kneaded product, is less than 50%. When the degree of fiberization of PTFE is 50% or more, the PTFE fiberized in the step of forming a sheet is formed into a lump, which causes cracks.

In step S2 of FIG. 7, the kneaded product is stretched into a sheet shape while being rolled. For the rolling in step S2, for example, a rolling mill can be used. For example, a pressure of 0.001 ton/cm or more and 4 ton/cm or less is set as a rolling condition, and rolling is performed once or a plurality of times to apply a shearing force to the polymer resin 33 to form a fiber. At that time, as described above, since the polymer resin 33 is uniformly dispersed in the kneaded product obtained in step S1, the polymer resin fibers 36 are formed inside the gas diffusion layer 3. In addition, the conductive particles 31, the conductive fibers 32, and the polymer resin 33 in the kneaded product, and the pressure and the number of times when the kneaded product is rolled are adjusted, so that a part of the polymer resin 33 remains as the polymer resin particles 35 without being formed into a fiber.

The degree of PTFE fiberization of the sheet prepared in this step is, for example, less than 50%.

In step S3 of FIG. 7, the kneaded product stretched into a sheet shape is fired to remove the surfactant and the dispersion solvent from the kneaded product.

In the firing in step S3, for example, an IR furnace, a hot air drying furnace, or the like can be used. The firing temperature is set to a temperature higher than the temperature at which the surfactant is decomposed and lower than the temperature at which the polymer resin 33 is melted. The reason is as follows. When the firing temperature is lower than the temperature at which the surfactant is decomposed, the surfactant remains in the gas diffusion layer 3, and the inside of the gas diffusion layer 3 becomes hydrophilic, so that water tends to be retained, and thus the gas permeability of the gas diffusion layer 3 may decrease. On the other hand, when the firing temperature is higher than the decomposition temperature of the polymer resin 33, the polymer resin 33 is decomposed, so that the mechanical strength of the gas diffusion layer 3 may be reduced. Specifically, for example, when PTFE is used as the polymer resin 32, the firing temperature is preferably 280° C. or more and 340° C. or less.

In step S4 of FIG. 7, the sheet-shaped kneaded product from which the surfactant and the dispersion solvent have been removed is re-rolled by a roll press machine to adjust the thickness. Thus, the gas diffusion layer 3 according to the first embodiment of the present disclosure can be manufactured.

For re-rolling in step S4, for example, a roll press machine can be used. For example, the thickness and porosity of the gas diffusion layer 3 can be adjusted by performing re-rolling once or a plurality of times under the conditions of roll pressing at a pressure of 0.01 ton/cm or more and 4 ton/cm or less.

The prepared gas diffusion layer 3 has a degree of PTFE fiberization of 50% or more.

### <Method 2 for Manufacturing Gas Diffusion Layer 3>

Next, a method for manufacturing the gas diffusion layer 3 according to the third embodiment will be described with reference to FIG. 8.

In step S1 of FIG. 8, conductive particles 31, conductive fibers 32, a polymer resin 33, crushing auxiliary particles 34 having a specific gravity of 2 times or more the specific gravity of the conductive particles, a surfactant, and a dispersion solvent are kneaded. For the kneading of the material in step S1, for example, a planetary mixer, a rotation-revolution mixer, a kneader, a roll mill, or the like can be used. First, the conductive particles 31, the conductive fibers 32, the crushing auxiliary particles 34, the surfactant, and the dispersion solvent are charged, stirred, and kneaded, so that the crushing auxiliary particles 34 having a specific gravity larger than that of the conductive particles play a role of an abrasive, and the crushing effect during stirring of the conductive particles 31 and the conductive fibers 32 is promoted by the action of friction and centrifugal force. Thereafter, the polymer resin 33 is charged and stirred and kneaded again to obtain a kneaded product in which the polymer resin 33 is uniformly dispersed in the kneaded product.

In addition, by kneading the conductive particles 31, the conductive fibers 32, the polymer resin 33, and the crushing auxiliary particles 34 in a dispersion solution having an added amount of a dispersant of 1 wt % or more and 5 wt % or less, the mixture is kneaded in a paste state, and dispersibility can be enhanced. In a case where the added amount of the dispersant is less than 1 wt %, the conductive particles 31, the conductive fibers 32, and the crushing auxiliary particles 34 are not uniformly dispersed in the dispersion solvent, so that the structure of the gas diffusion layer 3 may be biased and the strength may be reduced. On the other hand, when the added amount of the dispersant is more than 5 wt %, the dispersant is excessive with respect to the conductive particles 31, the conductive fibers 32, and the crushing auxiliary particles 34. Therefore, since the shear force is not sufficiently applied due to the sliding of the materials at the time of rolling into a sheet shape in step S2, there is a possibility that the fiberization of the polymer resin 33 is reduced and the strength is reduced. Furthermore, a clay-like kneaded product can be obtained by adding the second conductive particles having a specific surface area of 2 times or more and 20 times or less with respect to the conductive particles 31 to the kneaded product obtained by kneading, for example, 10 times or more, and kneading again. By adjusting the viscosity of the kneaded product by selectively adsorbing the dispersant to the second conductive particles having a high specific surface area, it is possible to increase the shear force applied to the polymer resin 33 and increase the strength when rolling into a sheet shape in step S2.

The degree of fiberization of PTFE, which is a polymer resin of the kneaded product, is less than 50%. When the degree of fiberization of PTFE is 50% or more, the PTFE fiberized in the step of forming a sheet is formed into a lump, which causes cracks.

In step S2 of FIG. 8, the kneaded product is stretched into a sheet shape while being rolled. For the rolling in step S2, for example, a rolling mill can be used. For example, a pressure of 0.001 ton/cm or more and 4 ton/cm or less is set as a rolling condition, and rolling is performed once or a plurality of times to apply a shearing force to the polymer resin 33 to form a fiber. At that time, as described above, in the kneaded product obtained in step S1, the polymer resin 33 is uniformly dispersed by the crushing auxiliary particles 34, so that the polymer resin fibers 36 are formed inside the gas diffusion layer 3. In addition, by adjusting the ratio of the conductive particles 31, the conductive fibers 32, the polymer resin 33, and the crushing auxiliary particles 34 in the kneaded product, and the pressure and the number of times at the time of rolling the kneaded product, a part of the polymer resin 33 remains as the polymer resin particles 35 without being formed into a fiber.

The degree of PTFE fiberization of the sheet prepared in this step is less than 50%.

In step S3 of FIG. 8, the kneaded product stretched into a sheet shape is fired to remove the surfactant and the dispersion solvent from the kneaded product.

In the firing in step S3, for example, an IR furnace, a hot air drying furnace, or the like can be used. The firing temperature is set to a temperature higher than the temperature at which the surfactant is decomposed and lower than the temperature at which the polymer resin 33 is melted. The reason is as follows. When the firing temperature is lower than the temperature at which the surfactant is decomposed, the surfactant remains in the gas diffusion layer 3, and the inside of the gas diffusion layer 3 becomes hydrophilic, so that water tends to be retained, and thus the gas permeability of the gas diffusion layer 3 may decrease. On the other hand, when the firing temperature is higher than the decomposition temperature of the polymer resin 33, the polymer resin 33 is decomposed, so that the mechanical strength of the gas diffusion layer 3 may be reduced. Specifically, for example, when PTFE is used as the polymer resin 32, the firing temperature is preferably 280° C. or more and 340° C. or less.

In step S4 of FIG. 8, the sheet-shaped kneaded product from which the surfactant and the dispersion solvent have been removed is re-rolled by a roll press machine to adjust the thickness. Thus, the gas diffusion layer 3 according to the first embodiment of the present disclosure can be manufactured.

For re-rolling in step S4, for example, a roll press machine can be used. For example, the thickness and porosity of the gas diffusion layer 3 can be adjusted by performing re-rolling once or a plurality of times under the conditions of roll pressing at a pressure of 0.01 ton/cm or more and 4 ton/cm or less.

The prepared gas diffusion layer 3 has a degree of PTFE fiberization of 50% or more.

The present disclosure is not limited to the first to third embodiments, and can be implemented in various other modes.

### EXAMPLES

Hereinafter, examples of the present disclosure will be described. The following materials were used, and each evaluation was performed by the following method.
[Conductive particles 31] acetylene black (hereinafter, referred to as AB) (DENKA BLACK powdery material manufactured by DENKI KAGAKU KOGYO CO., LTD.),
[Conductive fibers 32] VGCF (VGCF-H manufactured by Showa Denko K.K.)
[Polymer resin 33] PTFE dispersion (manufactured by Daikin Industries, Ltd.), average particle diameter: 0.25 μm
[Crushing auxiliary particles 34] Cerium-containing oxide (Cerium oxide-S, manufactured by TAIYO KOKO CO., LTD.)
[Dispersion solvent] Surfactant (Newcol, manufactured by Nippon Nyukazai Co., Ltd.)

### Manufacture of Gas Diffusion Layer of First to Fifth Examples and First Comparative Example

A gas diffusion layer of first to fifth examples was manufactured as follows.
(1) First, conductive particles, conductive fibers, a polymer resin, and crushing auxiliary particles were blended in the ratios shown in the raw material compositions in Table 1, and kneaded in the added amounts of the dispersion solvents shown in Table 1 using a planetary mixer.
(2) Next, the kneaded product was rolled 5 times using a rolling mill under a rolling condition of 0.1 ton/cm.
(3) Thereafter, the rolled sheet was arranged in an IR furnace and fired at the temperature shown in Table 1 for 0.5 hours.
(4) The fired sheet was re-rolled 3 to 10 times using a roll press machine under a rolling condition of 1 ton/cm to obtain a gas diffusion layer having a thickness of 100 μm.

### (Evaluation Test)

In first to fifth examples and first comparative example, the tensile rupture strength of the gas diffusion layer was measured. The raw material conditions and evaluation results in first to fifth examples and comparative example are shown in Table 1.

The gas diffusion layer was punched into a dumbbell test piece (dumbbell-shaped No. 4) specified in JIS K6251 (corresponding to ISO 37:2011, “Rubber, vulcanized or thermoplastic-Determination of tensile stress-strain properties (MOD)”) using a Thomson die, and the tensile rupture strength was measured using a tensile compression tester (SVZ −200NB type manufactured by IMADA SEISAKUSHO CO., LTD).

### (Measurement of Degree of Fiberization and Degree of Cohesion)

In first to fifth examples and first comparative example, the degree of fiberization and the fiber amount of the gas diffusion layer were calculated by the method described in <Method for Calculating Degree of Fiberization and Fiber Amount of Polymer Resin in Gas Diffusion Layer 3>. The calculation results in first to fifth examples and comparative example are shown in Table 1.

### (Observation of State of PTFE)

SEM observation of the surface or cross section was performed to observe how PTFE was present.

TABLE 1

| | | | | | | | Comparative |
|---|---|---|---|---|---|---|---|
| | | Example | | | | | Example |
| | | 1 | 2 | 3 | 4 | 5 | 1 |
| Raw Material | Added Amount of Conductive | 10 | 10 | 10 | 9 | 9.9 | 10 |
| Composition | Particles 31 (wt %) | | | | | | |
| | Second Conductive Particle (wt %) | 0 | 0 | 0 | 0 | 0.1 | 0 |
| | Added Amount (wt %) of | 70 | 70 | 60 | 69 | 60 | 70 |
| | Conductive Fibers 32 | | | | | | |
| | Added Amount (wt %) of Polymer | 20 | 20 | 30 | 20 | 30 | 20 |
| | Resin 33 | | | | | | |
| | Added Amount (wt %) of Crushing | 0 | 0 | 0 | 2 | 0 | — |
| | Auxiliary Particles 34 | | | | | | |
| Step | Added Amount of Dispersion | 1.5 | 1.5 | 1.5 | 1.5 | 2.5 | 0.5 |
| | Solvent (wt %) | | | | | | |
| | Degree of PTFE Fiberization (%) of | 17 | 17 | 16 | 19 | 15 | 43 |
| | Kneaded Product | | | | | | |
| | Degree of PTFE Fiberization (%) of | 21 | 21 | 19 | 23 | 25 | 45 |
| | Sheet After Kneaded Product | | | | | | |
| | Rolling | | | | | | |
| | Firing Temperature (° C.) | 300 | 320 | 300 | 300 | 300 | 300 |
| Evaluation of | PTFE Single Particle | Present | Present | Present | Present | Present | Absent |
| Gas Diffusion | PTFE Particle Aggregation/Fusion | Present | Present | Present | Present | Present | Present |
| Layer | PTFE Film-like Body | Absent | Present | Absent | Absent | Absent | Absent |
| | Degree of fiberization (%) | 52 | 56 | 68 | 74.1 | 86.5 | 48.5 |
| | Fiber Amount (wt %) | 3.3 | 3.8 | 6.2 | 4.8 | 8.4 | 2.9 |
| | Tensile Rupture Strength (MPa) | 0.51 | 0.53 | 0.84 | 0.66 | 0.95 | 0.29 |

The gas diffusion layer according to the present disclosure is particularly useful as a member used for a fuel cell, and can be applied to applications such as a household cogeneration system, an automobile fuel cell, a mobile fuel cell, and a backup fuel cell.

### REFERENCE SIGNS LIST

100 fuel cell
1 polymer electrolyte membrane
2 catalyst layer
2a anode catalyst layer
2b cathode catalyst layer
3 gas diffusion layer
3a anode-side gas diffusion layer
3b cathode gas diffusion layer
4 separator
4a anode side separator
4b cathode side separator
5 fluid flow path
6 rib portion
10 battery cell
11 current collecting plate
12 insulating plate
13 end plate
20 membrane electrode assembly
31 conductive particle
32 conductive fiber
33 polymer resin
34 Crushing auxiliary particle
35 Single particle of polymer resin particle
36 Fibrous polymer resin fiber
37 Polymer resin in which two or more single polymer resin particles are aggregated and fused
38 Polymer resin in which polymer resin particles are melted to form film

What is claimed is:

1. A gas diffusion layer including a porous member, the porous member containing conductive particles, conductive fibers, and a polymer resin,
wherein the polymer resin has polymer resin particles presenting in particulate form, and
the polymer resin includes two or more polymer resin particles fused together in part.

2. The gas diffusion layer according to claim 1, wherein the polymer resin has polymer resin fibers presenting in fibrous form, and
when a degree of fiberization of the polymer resin is defined as a ratio of the polymer resin fibers to the polymer resin, a degree of fiberization of the polymer resin is 50% or more.

3. The gas diffusion layer according to claim 1, wherein the polymer resin has polymer resin fibers presenting in fibrous form, and
a fiber amount as a ratio of the polymer resin fibers to the entire porous member is 3 wt % or more.

4. The gas diffusion layer according to claim 1, wherein the polymer resin includes films formed by melting of two or more polymer resin particles.

5. The gas diffusion layer according to claim 1, further comprising crushing auxiliary particles having a specific gravity of 2 times or more and 20 times or less than the specific gravity of the conductive particles.

6. The gas diffusion layer according to claim 5, wherein the crushing auxiliary particles are cerium-containing oxide.

7. The gas diffusion layer according to claim 1, wherein the porous member contains:
5 wt % or more and less than 35 wt % of the conductive particles;
35 wt % or more and 80 wt % or less of the conductive fibers;
0 wt % or more and 40 wt % or less of the polymer resin; and
0 wt % or more and 30 wt % or less of the crushing auxiliary particles.

8. The gas diffusion layer according to claim 1, wherein the polymer resin contains polytetrafluoroethylene.

9. A membrane electrode assembly comprising:
the gas diffusion layer according to claim 1;
a pair of electrodes; and
an electrolyte membrane.

10. A fuel cell comprising:
the membrane electrode assembly according to claim 9; and
a current collecting plate.

11. A method for manufacturing a gas diffusion layer, the method comprising:
kneading conductive particles, conductive fibers, and a polymer resin in a dispersion solvent to obtain a kneaded product in which a degree of fiberization of the polymer resin is less than 50%; and
rolling the kneaded product to obtain a sheet in which the degree of fiberization of the polymer resin is less than 50%.

12. The method for manufacturing a gas diffusion layer according to claim 11, wherein the kneading is carried out in dispersion solution in which an added amount of a dispersant is 1 wt % or more and 5 wt % or less.

13. The method for manufacturing a gas diffusion layer according to claim 11, further comprising firing a sheet in which the polymer resin has a degree of fiberization of less than 50% to obtain a gas diffusion layer in which the polymer resin has a degree of fiberization of 50% or more.

14. A method for manufacturing a gas diffusion layer, the method comprising:
kneading conductive particles, conductive fibers, a polymer resin, and crushing auxiliary particles having a specific gravity of twice or more a specific gravity of the conductive particles, and crushing and dispersing the conductive particles, the conductive fibers, and the polymer resin with the crushing auxiliary particles to obtain a kneaded product; and
rolling the kneaded product obtained by the kneading, and forming a sheet to obtain a gas diffusion layer composed of the sheet.

15. The method for manufacturing a gas diffusion layer according to claim 12, further comprising:
adding second conductive particles having a specific surface area of 2 times or more and 20 times or less the conductive particles to the kneaded product obtained by the kneading and kneading the second conductive particles.
